(19) United States
(12) Patent Application Publication
(10) Pub. No.: US 2012/0092382 A1
(43) Pub. Date: Apr. 19, 2012

(54) SYSTEM AND METHOD FOR DISPLAYING IMAGES AS SLIDE SHOW IN ELECTRONIC DEVICE

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/175,094

(22) Filed: Jul. 1, 2011

(30) Foreign Application Priority Data
Oct. 19, 2010 (TW) 99135522

(51) Int. Cl. G06T 3/40

(52) U.S. Cl. 345/667; 345/660

(57) ABSTRACT

A slide show system of an electronic device includes a processing module, an image reading module, a scaling module and a presenting module. The processing module determines a display area on a screen of the electronic device. The image reading module reads a plurality of images according to a list of image indicators, wherein each image indicator localizes an image. The scaling module scales the plurality of images to fit the display area. The presenting module presents the plurality of images as a slide show in the display area.

### BACKGROUND

1. Technical Field

The disclosure generally relates to a system and method for displaying images as a slide show in an electronic device.

2. Description of Related Art

A slide show program is used to display a series of pre-chosen information, such as a plurality of images, which is done for artistic or instructional purposes. In a conventional manner, however, it is inefficient and not flexible to present images as a slide show.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a slide show system installed in an electronic device.

FIG. 2 is a schematic diagram of one embodiment of function modules of the slide show system of FIG. 1.

FIG. 3 is an operational flow diagram representing an exemplary embodiment for displaying images using the slide show system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

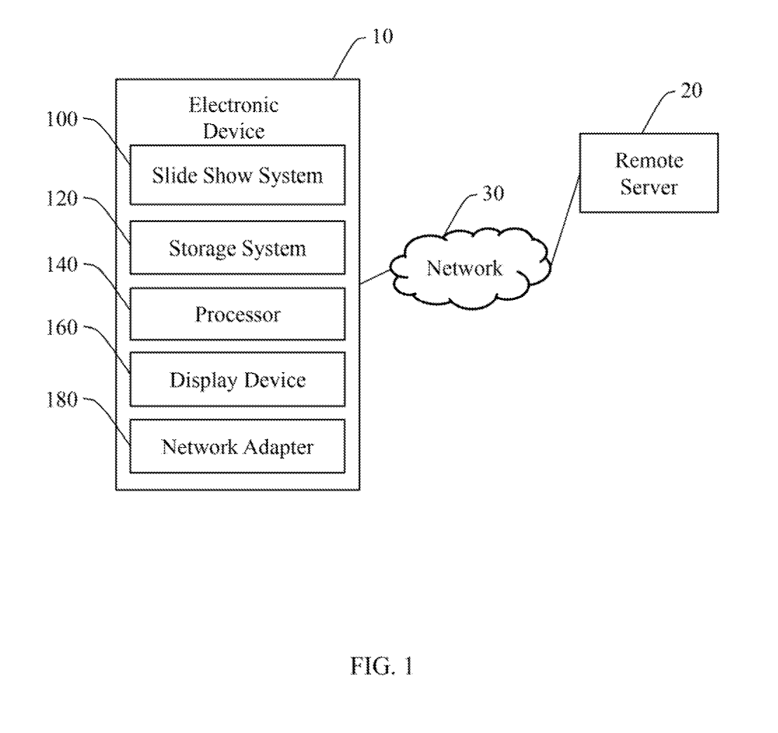

FIG. 1 is a schematic diagram of one embodiment of an electronic device 10. In the embodiment, the electronic device 10 may include a slide show system 100, a storage system 120, at least one processor 140, a display device 160, and a network adapter 180. The electronic device 10 implements the functions of the slide show system 100. The slide show system 100 may display images as a slide show on a screen of the display device 160. The displayed images can be read from both a local location, like the storage system 120, and a remote location, like a remote server 20 via a network 30. The electronic device 10 may be a desktop computer, a flat panel computer, a PDA or a smart phone.

In one embodiment, the storage system 120 may be a magnetic or an optical storage system, such as a hard disk drive, an optical drive, or a tape drive. The storage system 120 may store images that are intended to be presented as a slide show. The display device 160 has at least one display screen, such as a liquid crystal display (LCD) or a cathode-ray tube (CRT) display. The network adapter 180 may be a network interface card using a specific physical layer and data link layer standard such Ethernet or Wi-Fi. The network 30 may be a local area network (LAN) or a wide area network (WAN), such as Internet.

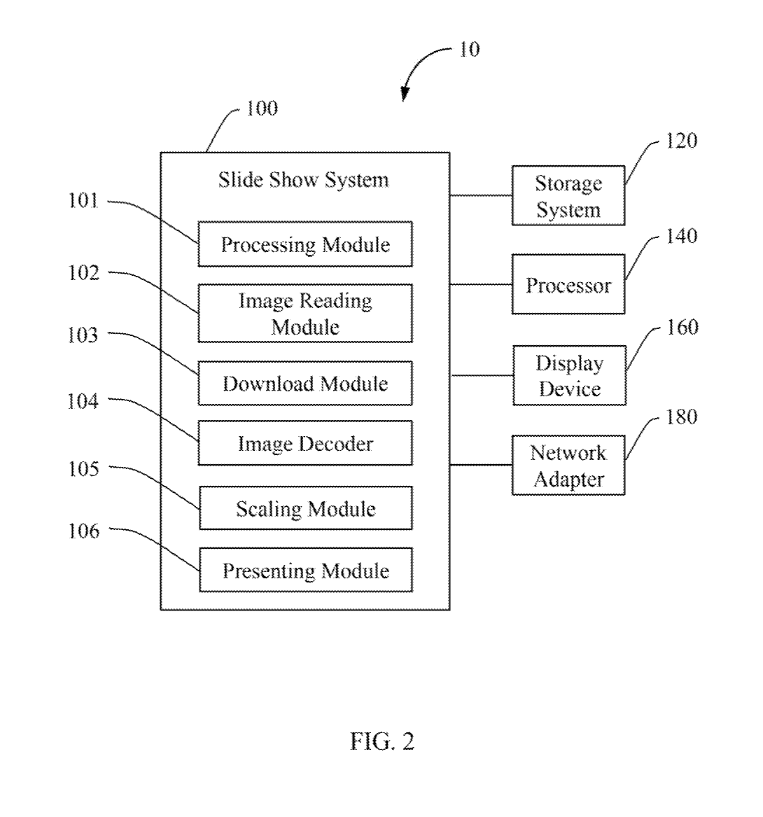

FIG. 2 is a schematic diagram of one embodiment of the function modules of the slide show system 100. In the embodiment, the slide show system 100 includes a processing module 101, an image reading module 102, a download module 103, an image decoder 104, a scaling module 105 and a presenting module 106. In some embodiments, each of the modules 101-106 may be a software program including one or more computerized instructions that are stored in the storage system 120 and executed by the processor 140.

The processing module 101 may determine a display area on a screen of the display device 160. The display area can be defined with a width and a height on the screen. For example, the display area is set up to full screen, of which the size is equal to the full size of the screen of the display device 160.

The image reading module 102 may read a plurality of images according to a list of image indicators. Each image indicator localizes an image. An image indicator may localize an image in a local location, such as the storage system 120. For example, an image indicator points to an image with a local storage path like C:\images\1.gif. An image indicator may also localize an image in a remote location, such as the remote server 20. For example, an image indicator is a uniform resource locator (URL) that localizes an image in a remote location, like http://www.a2b.com/tea.jpg. The remote server 20 may be an HTTP server, an FTP server or an NFS server.

If an image indicator is a URL, the download module 103 may download an image associated with that URL and store the downloaded image in a memory area of the storage system 120.

The image decoder 104 may decode the plurality of images into images in form of bitmap.

The scaling module 105 may obtain size of the display area and compare it with the size of an image. If the size of an image is smaller than the size of the display area, the scaling module 105 scales up the image to fit the display area. If the size of an image is larger than the size of the display area, the scaling module 105 scales down the image to fit the display area. If the size of an image is the same with the size of the display area, the scaling module 105 keeps original size of the image.

The presenting module 106 may present a slide show of the plurality of images in the display area. The slide show may be played in an auto mode or a manual mode. In the auto mode, the presenting module 106 may define a time interval for the slide show to specify how long each image will be presented before being switched, when the slide show is automatically playing. In the manual mode, the presenting module 106 may display and switch images according to a user operation. For example, in response to a user request for displaying a next image, the presenting module 106 displays the next image. In both the auto mode and the manual mode, the presenting module 106 may play, pause, or stop the slide show in response to the user operation to the slide show.

In one embodiment, the presenting module 106 may apply one or more effects to the slide show. An effect may be a fade in/out effect or a blinds effect.

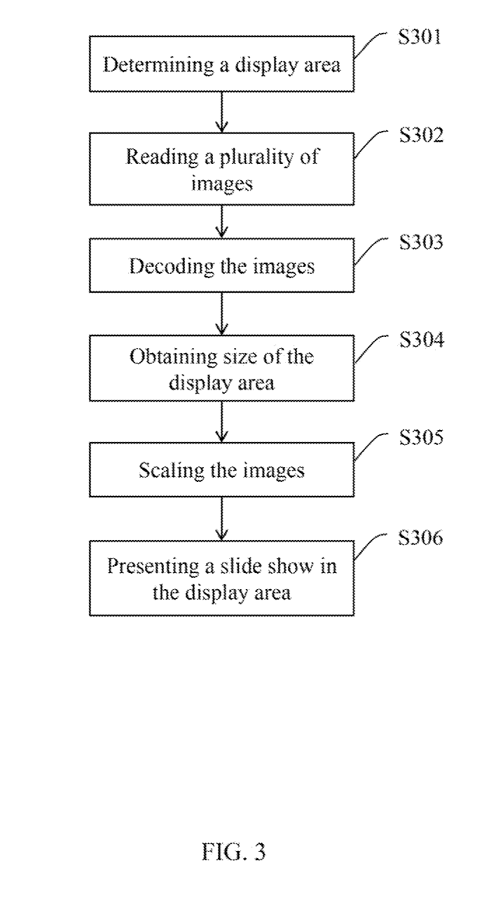

FIG. 3 is a flowchart illustrating one embodiment of a method of displaying images using the slide show system of FIG. 1. The method may include the following blocks.

In block S301, the processing module 101 determines a display area on a screen of the display device 160.

In block S302, the image reading module 102 reads a plurality of images according to a list of image indicators. If an image indicator is a URL, the download module 103 will download an image associated with that image indicator and store the downloaded image in a memory area of the storage system 120.

In block S303, the image decoder 104 decodes the plurality of images into images in form of bitmap.

In block S304, the scaling module 105 obtains the size of the display area.

In block S305, the scaling module 105 compares the size of the display area with the size of an image. If the size of an image is smaller than the size of the display area, the scaling module 105 scales up the image to fit the display area. If the size of an image is larger than the size of the display area, the scaling module 105 scales down the image to fit the display area. If the size of an image is the same with the size of the display area, the scaling module 105 keeps original size of the image.

In block S306, the presenting module 106 presents a slide show of the plurality of images in the display area. In one embodiment, the presenting module 106 defines a time interval for the slide show to specify how long each image will be presented before being switched when the slide show is automatically playing. In one embodiment, the presenting module 106 applies one or more effects to the slide show. In one embodiment, the presenting module 106 plays, pauses, or stops the slide show in response to the user operation to the slide show.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A computer-implemented method for displaying images as a slide show in an electronic device, comprising:
determining a display area on a screen of the electronic device;
reading a plurality of images according to a list of image indicators, wherein each image indicator localizes an image;
scaling the plurality of images to fit the display area; and
presenting the plurality of images, as a slide show, in the display area.

2. The method of claim 1, further comprising:
when an image indicator is a uniform resource locator (URL) that localizes an image of the plurality of images in a remote location, downloading the image associated with the image indicator; and
storing the image, downloaded from the remote location, in a memory area of the electronic device.

3. The method of claim 1, further comprising decoding the plurality of images into bitmaps.

4. The method of claim 1, wherein the scaling the plurality of images to fit the display area further comprises:
obtaining size of the display area;
when size of an image of the plurality of images is smaller than the size of the display area, scaling up the image;
when size of an image of the plurality of images is larger than the size of the display area, scaling down the image; and
when size of an image of the plurality of images is the same as the size of the display area, keeping original size of the image.

5. The method of claim 1, further comprising defining a time interval for the slide show to specify how long each of the plurality of images will be presented before being switched when the slide show is automatically playing.

6. The method of claim 1, further comprising applying one or more effects to the slide show.

7. The method of claim 1, further comprising playing, pausing, or stopping the slide show in response to a user operation to the slide show.

8. A system for displaying images as a slide show in an electronic device, comprising:
a processing module adapted to determine a display area on a screen of the electronic device;
an image reading module adapted to read a plurality of images according to a list of image indicators, wherein each image indicator localizes an image;
a scaling module adapted to scale the plurality of images to fit the display area; and
a presenting module adapted to present the plurality of images as a slide show in the display area.

9. The system of claim 8, further comprising a download module adapted to download an image of the plurality of images associated with an image indicator, the image indicator being a uniform resource locator (URL) that localizes the image in a remote location and store the image, downloaded from the remote location, in a memory area of the electronic device.

10. The system of claim 8, further comprising an image decoder adapted to decode the plurality of images into bitmaps.

11. The system of claim 8, wherein the scaling module is further adapted to obtain size of the display area, scale up an image when size of the image is smaller than the size of the display area, scale down an image when size of the image is larger than the size of the display area, and keep original size of an image when size of the image is the same with the display area.

12. The system of claim 8, wherein the presenting module is further adapted to define a time interval for the slide show to specify how long each of the plurality of images will be presented before being switched when the slide show is automatically playing.

13. The system of claim 12, wherein the presenting module is further adapted to apply one or more effects to the slide show.

14. The system of claim 8, wherein the presenting module is further adapted to play, pause, or stop the slide show in response to a user operation to the slide show.

15. A computer-implemented method for displaying images as a slide show in an electronic device, comprising:
providing a processing module, an image reading module, a scaling module, and a presenting module;
determining a display area on a screen of the electronic device by the processing module;
reading a plurality of images according to a list of image indicators by the image reading module, wherein each image indicator localizes an image;
scaling the plurality of images to fit the display area by the scaling module; and
presenting the plurality of images, as a slide show, in the display area by the presenting module.
